(19) United States
(12) Patent Application Publication
(10) Pub. No.: US 2011/0318093 A1
(43) Pub. Date: Dec. 29, 2011

(54) UNIVERSAL FASTENING APPARATUS

(76) Inventor: CHIN-HUI LIAO, Taichung City (TW)

(21) Appl. No.: 12/823,025

(22) Filed: Jun. 24, 2010

(51) Int. Cl. F16C 11/06

(52) U.S. Cl. 403/142

(57) ABSTRACT

A universal fastening apparatus of the present invention includes a primary clamping portion, a first ball unit, a secondary clamping portion, a second ball unit and a pressing means. The primary clamping portion has a pair of primary clamping units defining a first rotary space and a second rotary space therebetween. The second rotary space includes an annular slot. The first rotary space includes a first spherical slot for the first ball of the first ball unit to selectively-rotatably dispose therein. The secondary clamping portion has a received end and a clamping end, and includes a pair of secondary clamping units defining a third rotary space therebetween. The third rotary space includes a second spherical slot. The received end is selectively rotatably disposed in the annular slot. The second ball of the second ball unit is selectively-rotatably disposed in the second spherical slot.

### BACKGROUND OF THE INVENTION

1. Field of the Invention

The present invention relates to a universal fastening apparatus.

2. Description of the Prior Art

The modern life is getting more and more convenient mainly because of the digitalization of information. Accordingly, many people carry 3C electronic device with them, such as PDA, notebook computers or GPS.

To position the 3C electronic device in a narrow space, such as in a car, a fastening apparatus is needed. The conventional fastening apparatus is provided with rotatable joints, but they are not convenient for the user to adjust their angles.

The present invention is, therefore, arisen to obviate or at least mitigate the above mentioned disadvantages.

### SUMMARY OF THE INVENTION

The main object of the present invention is to provide a universal fastening apparatus with three rotatable joints which can be simultaneously fixed by a single pressing means.

To achieve the above and other objects, a universal fastening apparatus of the present invention includes a primary clamping portion, a first ball unit, a secondary clamping portion, a second ball unit and a pressing means. The primary clamping portion has a first end and a second end, and the primary clamping portion includes a pair of primary clamping units which define a first rotary space and a second rotary space therebetween. The first rotary space is adjacent to the first end, and the second rotary space is adjacent to the second end. The first rotary space includes a first spherical slot, while the second rotary space includes an annular slot. The annular slot has an opening located at the second end of the primary clamping portion. A bore diameter of the opening is smaller than the biggest diameter of the annular slot. The first ball unit has a first ball and a first neck extending from the first ball. The first ball is selectively rotatably disposed in the first spherical slot. The secondary clamping portion has a received end and a clamping end, and the secondary clamping portion includes a pair of secondary clamping units. The received end is defined at lower ends of the secondary clamping units. A third rotary space is defined between the secondary clamping units, and the third rotary space is adjacent to the clamping end. Further, the third rotary space includes a second spherical slot. The received end is selectively rotatably disposed in the annular slot. The second ball unit has a second ball and a second neck extending from the second ball. The second ball is selectively rotatably disposed in the second spherical slot. The pressing means is for pressing the primary clamping units to tightly clamp the first ball and the received end so that the first ball and the received end become non-rotatable with respect to the primary clamping portion, and for further pressing the second clamping units to tightly clamp the second ball so that the second ball becomes non-rotatable with respect to the secondary clamping portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention;

FIG. 2 is a combination drawing showing a first embodiment of the present invention;

FIG. 3 is a profile showing a first embodiment of the present invention;

FIG. 4 is a profile showing a second embodiment of the present invention;

FIG. 5 is a profile showing a third embodiment of the present invention.

### DETAILED DESCRIPTION OF THE PREFERRED EMBODIMENTS

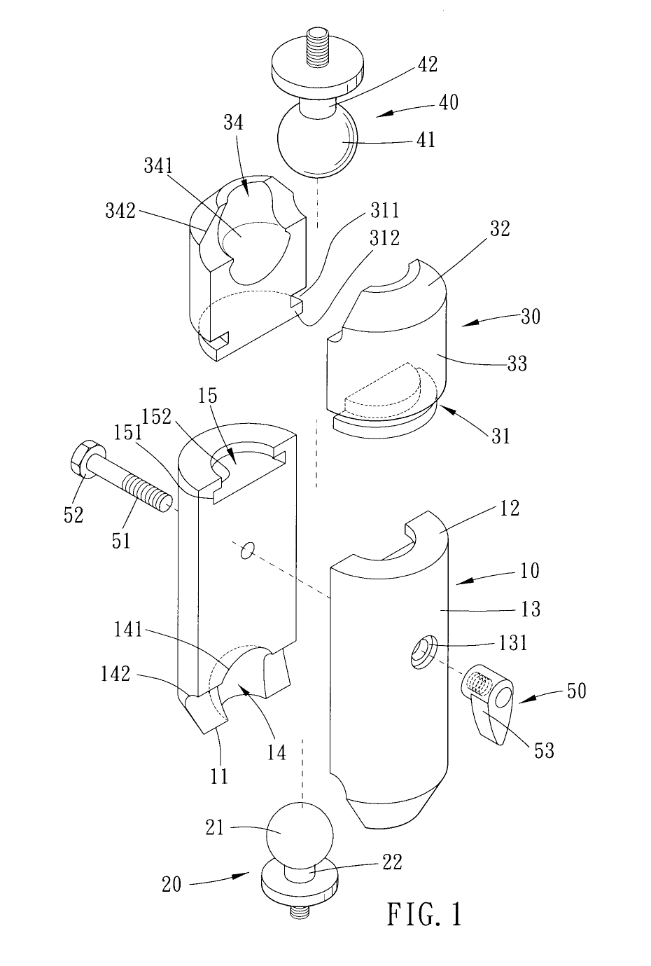

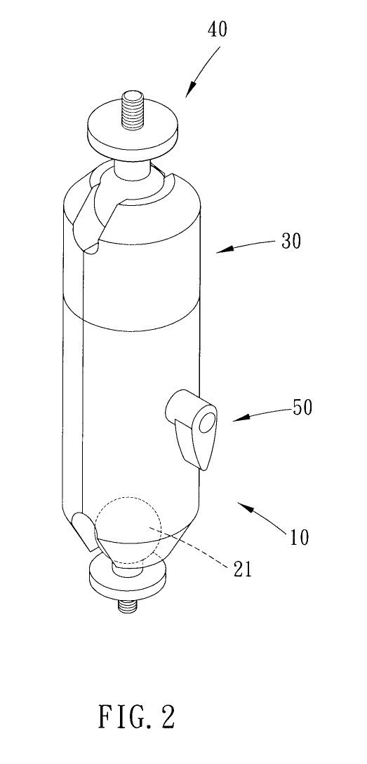

Please refer to FIG. 1 to FIG. 3 for a first embodiment of the present invention. The universal fastening apparatus of the present embodiment includes a primary clamping portion 10, a first ball unit 20, a secondary clamping portion 30, a second ball unit 40 and a pressing means 50.

The primary clamping portion 10 has a first end 11 and a second end 12, and the primary clamping portion 10 includes a pair of primary clamping units 13, which define a first rotary space 14 and a second rotary space 15 therebetween. The first rotary space 14 is adjacent to the first end 11, and the second rotary space 15 is adjacent to the second end 12. The primary clamping portion 10 may further include a pair of laterally-oriented first slots 142 located adjacent to the first end 11. The first rotary space 14 includes a first spherical slot 141, with which the first slots 142 communicated. More specifically, the first slots 142 are axially extended from the first end 11. The second rotary space 15 includes an annular slot 151, which has an opening 152 located at the second end 12. A bore diameter of the opening 152 is smaller than the biggest diameter of the annular slot 151. Furthermore, each primary clamping unit 13 may be formed with a lateral through hole 131. One of the through holes 131 of the clamping units 13 is threaded. Nevertheless, both of the through holes may be formed without threads in some possible embodiments of the present invention.

The first ball unit 20 has a first ball 21 and a first neck 22 extending from the first ball 21. In other words, the first ball 21 is disposed on one end of the first neck 22. The other end of the first neck 22 may be a fixed end, e.g. the fixed end may be formed with threads to be fixed on a predetermined position. The first ball 21 is selectively rotatably disposed in the first spherical slot 141, and the first neck 22 is selectively swayable to dispose in one of the first slots 142. As such, the primary clamping portion 10 is pivotable with respect to the first ball unit 20 in two axial directions.

The secondary clamping portion 30 has a received end 31 and a clamping end 32, and the secondary clamping portion 30 includes a pair of secondary clamping units 33 which define a third rotary space 34 therebetween. The received end 31 is defined at lower ends of the secondary clamping units 33. The third rotary space 34 is adjacent to the clamping end 32 and includes a second spherical slot 341. The secondary clamping portion 30 further includes a pair of laterally-oriented second slots 342 located adjacent to the clamping end 32. The second slots 342 communicate with the second spherical slot 341 and are axially extended from the clamping end 32. The received end 31 is selectively rotatably disposed in the annular slot 151, and is restrained in the annular slot 151 because of the narrow opening 152.

The second ball unit 40 has a second ball 41 and a second neck 42 extending from the second ball 41. In other words, the second ball 41 is disposed on one end of the second neck 42, and the other end of the second neck 42 is formed with threads to mate with a deck or a 3C electronic device. The second ball 41 is selectively rotatably disposed in the second spherical slot 341, while the second neck 42 is selectively swayable to dispose in one of the second slots 342. As such, the secondary clamping portion 30 is also pivotable with respect to the second ball unit 40 in two axial directions.

The pressing means 50 of the present invention is for pressing the primary clamping units 13 to tightly clamp the first ball 21 and the received end 31, and for further pressing the secondary clamping units 33 to tightly clamp the second ball 41. As such, the first ball 21 and the secondary clamping portion 30 become non-rotatable with respect to the primary clamping portion 10, and the second ball 41 become non-rotatable with respect to the secondary clamping portion 30. That is, these three joints can be simultaneously fixed by a single pressing means 50.

More specifically, the pressing means 50 may include a screw unit which laterally threaded with the primary clamping portion so as to selectively press the primary clamping units 13 toward each other. Preferably, the screw unit is formed with a grip portion for the user to turn by a bare hand. Or, the pressing means 50, as shown in FIG. 1, may include a screw 51, a nut 52 and a grip element 53. The screw 51 is extended from the nut 52 and pierces through the through holes 131 of the primary clamping units 13 and mate with the grip element 53, so as to selectively press the clamping units 13 toward each other. Of course, the pressing means 50 can be further formed with cam structure(s) to rapid fasten/release the pressing means.

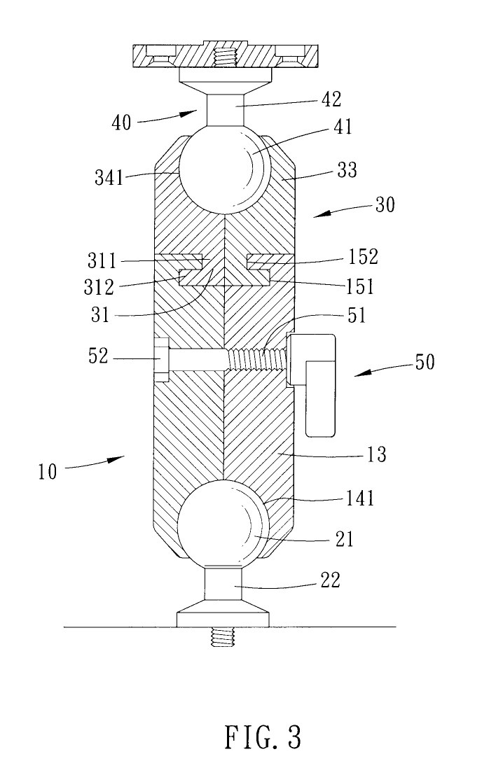

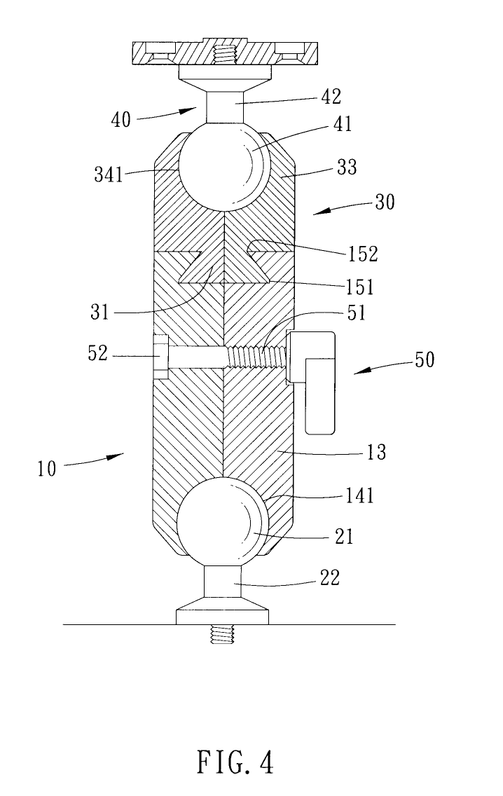

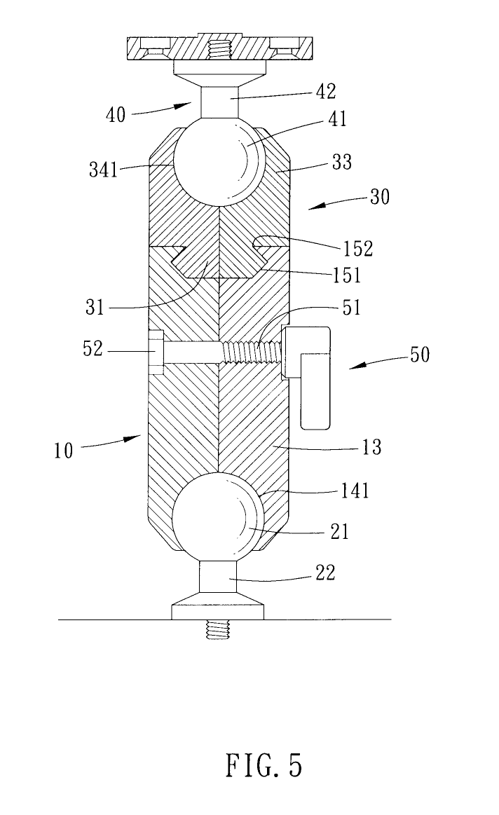

As shown in FIG. 3, the received end 31 may include a neck portion 311 and a head 312 to rotatably dispose in the second rotary space. Or, the profile of the received end 31 may be dovetail, and thus the received end 31 can also be restrained in the annular slot, as shown in FIG. 4. The profile of the received end 31 may also be diamond as shown in FIG. 5. That is, the biggest diameter of the received end 31 locates at the middle portion thereof, so as to be rotatably restrained in the annular slot, and the shape of the received end is thus variable.

What is claimed is:

1. A universal fastening apparatus, comprising:
a primary clamping portion, having a first end and a second end, the primary clamping portion comprising a pair of primary clamping units, a first rotary space and a second rotary space being defined between the primary clamping units, the first rotary space being adjacent to the first end, the second rotary space being adjacent to the second end, the first rotary space comprising a first spherical slot, the second rotary space comprising an annular slot, the annular slot having an opening located at the second end of the primary clamping portion, a bore diameter of the opening being smaller than a biggest diameter of the annular slot;
a first ball unit, having a first ball and a first neck extending from the first ball, the first ball being selectively rotatably disposed in the first spherical slot;
a secondary clamping portion, having a received end and a clamping end, the secondary clamping portion comprising a pair of secondary clamping units, the received end being defined at lower ends of the secondary clamping units, a third rotary space being defined between the secondary clamping units, the third rotary space being adjacent to the clamping end, the third rotary space comprising a second spherical slot, the received end being selectively rotatably disposed in the annular slot;
a second ball unit, having a second ball and a second neck extending from the second ball, the second ball being selectively rotatably disposed in the second spherical slot;
a pressing means for pressing the primary clamping units to tightly clamp the first ball and the received end of the secondary clamping portion so that the first ball and the received end become non-rotatable with respect to the primary clamping portion, and for further pressing the secondary clamping units to tightly clamp the second ball so that the second ball becomes non-rotatable with respect to the secondary clamping portion.

2. The apparatus of claim 1, wherein the pressing means comprises a screw unit, the screw unit laterally threaded with the primary clamping units so as to selectively press the primary clamping units toward each other.

3. The apparatus of claim 1, wherein the pressing means comprising a screw and a nut, each of the primary clamping units is formed with a lateral through hole, the screw pierces through the through holes and mate with the nut so as to selectively press the primary clamping units toward each other.

4. The apparatus of claim 1, wherein the secondary clamping portion further has a pair of laterally-oriented second slots, which communicate with the second spherical slot and are adjacent to the clamping end, the second neck is selectively swayable to dispose in one of the second slots.

5. The apparatus of claim 1, wherein the primary clamping portion further has a pair of laterally-oriented first slots, which communicate with the first spherical slot and are adjacent to the first end, the first neck is selectively swayable to dispose in one of the first slots.
